(19) United States
(12) Patent Application Publication
(10) Pub. No.: US 2008/0266251 A1
(43) Pub. Date: Oct. 30, 2008

(54) CURSOR CONTROL DEVICE AND METHOD FOR AN IMAGE DISPLAY, AND IMAGE SYSTEM

(75) Inventors: Tzu Yi Chao, Hsin-Chu (TW); Hsin Chia Chen, Hsin-Chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., Hsin-Chu County (TW)

(21) Appl. No.: 12/103,132

(22) Filed: Apr. 15, 2008

(30) Foreign Application Priority Data
Apr. 24, 2007 (TW) 096114378

(51) Int. Cl. G06F 3/033

(52) U.S. Cl. 345/157; 345/166; 345/164

(57) ABSTRACT

A cursor control device for an image display includes a first sensing unit, a second sensing unit and a switching device. The first sensing unit is for detecting a first displacement of the cursor control device with respect to a surface and calculating a first coordinate variation of a cursor on the image display according to the first displacement. The second sensing unit is for sensing an object, detecting a second displacement of the cursor control device with respect to the object and calculating a second coordinate variation of the cursor on the image display according to the second displacement. The switching device switches output between the first coordinate variation and the second coordinate variation. The present invention further provides an image system and a cursor control method for an image display.

### CROSS REFERENCE TO RELATED APPLICATION

This application claims the priority benefit of Taiwan Patent Application Serial Number 096114378, filed on Apr. 24, 2007, the full disclosure of which is incorporated herein by reference.

### BACKGROUND OF THE INVENTION

1. Field of the Invention

This invention generally relates to a cursor control device and a cursor control method for an image display; and an image system, which can implement the control of a cursor on an image display in two ways by utilizing a switching mechanism.

2. Description of the Related Art

In a conventional image display, e.g. a computer screen, the motion of a cursor shown on the image display can be accordingly controlled according to a displacement of an optical navigation sensor, e.g. a mouse, on a surface, wherein the displacement is determined by capturing images at different time with the optical navigation sensor and by comparing the relativities of the images captured at different time. In order to execute, for example a shooting game, on the image display, a user has to further purchase a pointer positioning device, such as the pointer positioning device of a video camera disclosed in Taiwan Patent No. 267,754, wherein the pointer positioning device is installed with a control circuit which connects to a video camera, a calculation unit and a communication interface, respectively. The communication interface is connected to a host. An optical filter is installed in the front end of the video camera, and a plurality of light-emitting components allowing the video camera to capture images are installed on the screen of the image display. When a user uses the pointer positioning device to execute a host program, he can use the video camera to shoot the screen. And since the camera is installed with the optical filter, light with a spectrum outside the spectrum of the light generated from the light-emitting components will be blocked such that the pictures captured by the video camera will include only the images of those light-emitting components. Then the calculation unit calculates coordinate values of the aiming point of the video camera on the screen which will then be transmitted to the host, such that the host can perform the cursor control of the image display through these coordinate values.

However in practical use, purchasing another pointer positioning device will not only increase the cost, but also has the problem of storage when the pointer positioning device is unused. According to the above reasons, it is necessary to further improve the conventional cursor control device and method for an image display so as to increase the practicability of the image display.

### SUMMARY OF THE INVENTION

It is an object of the present invention to provide a cursor control device and a cursor control method for an image display, wherein the motion of a cursor on the image display can be controlled in two ways by means of a switching mechanism thereby increasing the practicability of the image display.

It is another object of the present invention to provide an image system which combines two control ways in a single cursor control device so as to simplify the system structure and decrease the cost thereof.

In order to achieve the above objects, the present invention provides a cursor control device for an image display including a first sensing unit, a second sensing unit and a switching device. The first sensing unit is for detecting a first displacement of the cursor control device with respect to a surface and calculating a first coordinate variation of a cursor on the image display according to the first displacement. The second sensing unit is for sensing an object, detecting a second displacement of the cursor control device with respect to the object and calculating a second coordinate variation of the cursor on the image display according to the second displacement. The switching device switches output between the first coordinate variation and the second coordinate variation.

According to another aspect of the present invention, the present invent further provides an image system including an image display, at least one object, a cursor control device and a coordinate processor. The image display has a screen for displaying image pictures with a cursor shown thereon. The cursor control device includes a first sensing unit for detecting a first displacement of the cursor control device with respect to a surface and calculating a first coordinate variation of the cursor according to the first displacement; a second sensing unit for sensing the object, detecting a second displacement of the cursor control device with respect to the object and calculating a second coordinate variation of the cursor according to the second displacement; a switching device for switching output between the first coordinate variation and the second coordinate variation; and a communication interface unit for transmitting the first or the second coordinate variation selected to be outputted by the switching device. The coordinate processor receives the first or the second coordinate variation from the communication interface unit and combines the first or the second coordinate variation with the coordinate of the cursor shown on the image display such that the cursor control device can accordingly control the motion of the cursor on the screen.

According to an alternative aspect of the present invention, the present invention further provides a cursor control method for an image display including: providing a cursor control device including a first sensing unit and a second sensing unit; detecting a first displacement of the cursor control device with respect to a surface and calculating a first coordinate variation of a cursor on the image display according to the first displacement with the first sensing unit; sensing an object, detecting a second displacement of the cursor control device with respect to the object and calculating a second coordinate variation of the cursor on the image display according to the second displacement with the second sensing unit; and outputting the first coordinate variation or the coordinate variation from the cursor control device.

According to a further alternative embodiment, the present invention further provides a cursor control method for an image display including: providing a cursor control device including a first sensing unit and a second sensing unit; detecting a first displacement of the cursor control device with respect to a surface and calculating a first coordinate variation of a cursor on the image display according to the first displacement with the first sensing unit; outputting the first coordinate variation from the cursor control device when a predetermined condition is met; and sensing an object, detecting a second displacement of the cursor control device with respect to the object and calculating a second coordinate variation of the cursor on the image display according to the second displacement with the second sensing unit, and outputting the second coordinate variation from the cursor control device when the predetermined condition is not met.

The cursor control device and method of the present invention can be adapted to the cursor control of any image display, e.g. a computer screen, a game machine screen or a projection screen. A user can select one of two ways to control an image display thereby significantly increasing the practicability of the image display.

### BRIEF DESCRIPTION OF THE DRAWINGS

Other objects, advantages, and novel features of the present invention will become more apparent from the following detailed description when taken in conjunction with the accompanying drawings.

FIG. 1a shows a schematic view of the image system according to one embodiment of the present invention.

FIG. 1b shows another schematic view of the image system according to one embodiment of the present invention.

FIG. 2 shows a schematic view of the cursor control device according to the first embodiment of the present invention.

FIG. 3 shows a block diagram of the cursor control device according to the first embodiment of the present invention.

FIG. 4 shows a flow chart of the cursor control method according to the first embodiment of the present invention.

FIG. 5a shows a schematic view of image pixels of a first image frame captured by the first sensor of the cursor control device according to the embodiment of the present invention.

FIG. 5b shows a schematic view of image pixels of a second image frame captured by the first sensor of the cursor control device according to the embodiment of the present invention.

FIG. 6 shows a flow chart of the method for calculating the second coordinate variation by the second sensor of the cursor control device according to the embodiment of the present invention.

FIG. 7a shows a schematic view of images of the objects captured by the second sensor of the cursor control device according to the embodiment of the present invention.

FIG. 7b shows another schematic view of images of the objects captured by the second sensor of the cursor control device according to the embodiment of the present invention, wherein the second sensor is rotated by an angle θ during operation.

FIG. 8 shows a schematic view of images of the objects captured at different distances from the objects by the second sensor of the cursor control device according to the embodiment of the present invention.

FIG. 9 shows a schematic view of images of the objects captured at different aiming points by the second sensor of the cursor control device according to the embodiment of the present invention.

FIG. 10 shows a block diagram of the cursor control device according to the second embodiment of the present invention.

FIG. 11 shows a flow chart of the cursor control method according to the second embodiment of the present invention.

FIG. 12 shows a schematic view of an image in one dimension captured by the image sensor array of the first sensor of the cursor control device, wherein the amplitude variations represent the intensity values of the image in one dimension.

FIG. 13 shows a schematic view of the cursor control device according to an alternative embodiment of the present invention.

FIG. 14 shows a schematic view of the cursor control device according to a further alternative embodiment of the present invention.

### DETAILED DESCRIPTION OF THE PREFERRED EMBODIMENT

It should be noticed that, wherever possible, the same reference numbers will be used throughout the drawings to refer to the same or like parts.

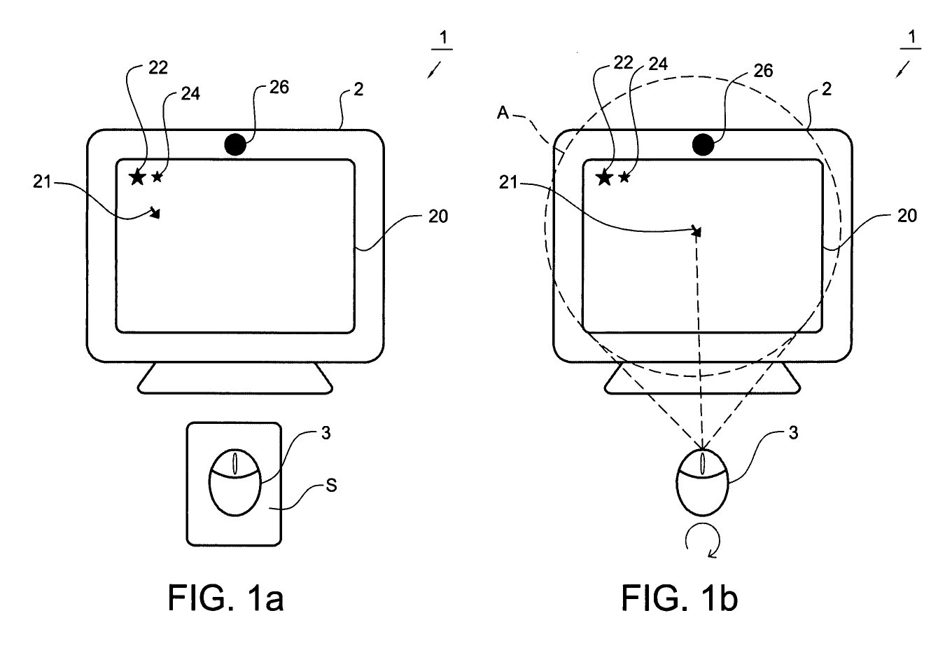

Referring to FIGS. 1a and 1b, they show schematic views of the image system 1 according to the embodiment of the present invention. The image system 1 includes an image display 2 and a cursor control device 3. Embodiments of the image display 2 include a computer screen, a game machine screen, a projection screen and any other devices for showing images. Corresponding to the type of the image display 2, the cursor control device 3 may be a mouse device or a game control device. The cursor control device 3 can be placed on a surface S, e.g. a mouse pad or a table surface, for being moved so as to accordingly control the motion of a cursor 21 on the image display 2, as shown in FIG. 1a. In addition, the cursor control device 3 also can be held by a user (not shown) with his hand so as to perform the positioning and control of the cursor 21 on the image display 2, as shown in FIG. 1b. The cursor control device 3 can be electrically (wired) or wirelessly coupled to the image display 2.

The image display 2 has a screen 20 for displaying images, and preferably a cursor 21 is shown on the screen 20 for a user to control the setting or displaying status of the image display 2. For example, a user can control the setting of displaying status, or the setting and operation of games of the image display 2 through an application software, e.g. a user interface, a game interface or the like. By using a coordinate processor (not shown), which may be installed in the image display 2, coordinate variations of the cursor 21 calculated by the cursor control device 3 can be combined with the coordinate of the cursor 21 and be shown on the screen 20 so as to accordingly control the motion of the cursor 21. An object 26 for reference, e.g. a light source, can be disposed around the screen 20 of the image display 2, and the light source, for example, may be formed by arranging at least one light emitting diode together. Although the object 26 is shown as a circular shape herein, it is only an exemplary embodiment and the object 26 can also be in other shapes. In an alternative embodiment, objects 22 and 24 can be shown on the screen 20 of the image display 2, wherein the objects 22 and 24 can be still objects of predetermined shapes displayed on the screen 20 without affecting the displaying of images. For example in FIGS. 1a and 1b, two objects 22 and 24 with a star shape are shown at the corner of the screen 20. In other embodiment, the objects can be shown as any other shapes and at any location on the screen 21. In other embodiment, the object 26 may be displaced near the image display 2 rather than be integrated thereon. The objects 22, 24 and 26 are served as reference points for the positioning and control of the cursor 21, and the details will be illustrated in the following paragraphs.

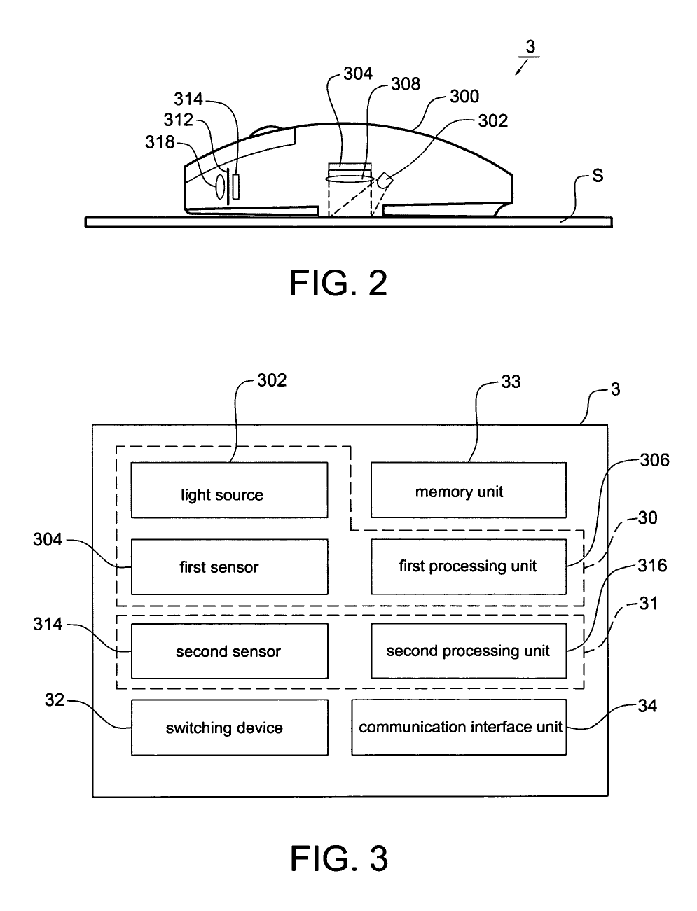

Referring to FIGS. 2 and 3, they respectively show a schematic view and a block diagram of the cursor control device 3 according to the first embodiment of the present invention. The cursor control device 3 includes a house 300; a first sensing unit 30, a second sensing unit 31, a switching device 32, a memory unit 33 and a communication interface unit 34 are disposed inside the house 300. The first sensing unit 30 is for detecting a first displacement of the cursor control device 3 with respect to the surface S and calculating a first coordinate variation of the cursor 21 according to the first displacement. The first coordinate variation will then be electrically (through wire) or wirelessly transmitted to the coordinate processor through the communication interface unit 34 to be combined with the coordinate of the cursor 21 on the screen 20 so as to accordingly control the displaying and setting of the image display 2. The second sensing unit 31 is for sensing the objects 22 and 24 or the object 26, detecting a second displacement of the cursor control device 3 with respect to the objects 22 and 24 or the object 26, and calculating a second coordinate variation of the cursor 21 according to the second displacement. Similarly, the second coordinate variation will be electrically or wirelessly transmitted to the coordinate processor through the communication interface unit 34 to be combined with the coordinate of the cursor 21 on the screen 20 so as to accordingly control the displaying and setting of the image display 2, wherein all parameters generated in the processes of calculating the first and second coordinate variations and the first and second coordinate variations themselves can all be stored in the memory unit 33. The switching device 32 switches between the first sensing unit 30 and the second sensing unit 31 such that a user can select one of the first sensing unit 30 and the second sensing unit 31 to control the displaying and setting of the image display 2. Embodiments of the switching device 32 include a bottom switch, a mercury switch, a G-sensor, a light sensing switch, a resistive switch, a capacitive switch and any switch device for selecting between two options.

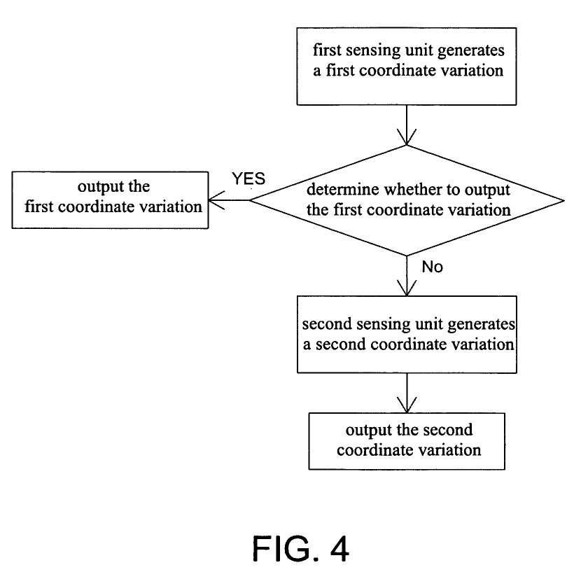

Referring to FIGS. 2, 3 and 4, FIG. 4 shows a flow chart of a cursor control method for the image display 2 according to the embodiment of the present invention. The cursor control method includes the steps of: detecting a first displacement of the cursor control device 3 with respect to the surface S and calculating a first coordinate variation of the cursor 21 on the image display 2 according to the first displacement with the first sensing unit 31; determining whether to output the first coordinate variation, if yes, outputting the first coordinate variation; and sensing the objects 22 and 24 or the object 26, detecting a second displacement of the cursor control device 3 with respect to the objects 22 and 24 or the object 26, and calculating a second coordinate variation of the cursor 21 on the image display 2 according to the second displacement with the second sensing unit 31, and outputting the second coordinate variation; wherein a condition to determine whether to output the first coordinate variation is defined as identifying whether the switching device 32 is triggered. For example, when the switching device 32 is a pressure switch and the cursor control device 3 leaves the surface S so as to trigger the pressure switch, it is determined to output the second coordinate variation. On the contrary, when the cursor control device 3 remains on the surface S, it is determined to output the first coordinate variation; however, the above example is just an exemplary embodiment and is not used to limit the present invention.

Referring to FIGS. 2 and 3 again, in the first embodiment, the first sensing unit 30 includes a light source 302, a first sensor 304, a first processing unit 306 and a lens 308. The light source 302 lights the surface S through an opening under the house 300, and embodiments of the light source 302 include a light emitting diode and a laser diode, e.g. an infrared light emitting diode or an infrared laser diode. Embodiments of the first sensor 304 include a charge-coupled device image sensor (CCD image sensor), complementary metal oxide semiconductor image sensor (CMOS image sensor) and the like. The first sensor 304 is for continuously capturing at least two image frames of a first image reflected from the surface S. The first processing unit 306 calculates a first displacement of the cursor control device 3 with respect to the surface S according to a variation between the image frames of the first image and calculates a first coordinate variation of the cursor 21 according to the first displacement. The lens 308 is disposed in front of the first sensor 304 for taking images in focus; however, it is not necessary to install the lens 308.

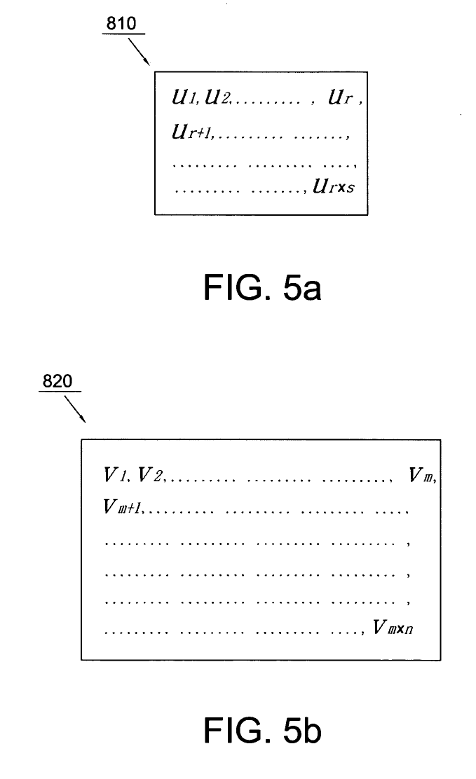

Referring to FIGS. 2, 3, 5a and 5b, an example for calculating the first displacement is illustrated hereinafter. First, the first sensor 304 captures a first image frame 810 and a second image frame 820 of the surface S. The first image frame 810 includes a plurality of image pixels u₁, u₂, . . . , uᵣ, uᵣ₊₁, . . . , u_{r×s}, and each pixel uᵢ, wherein i=1 to r×s, includes at least a coordinate information and an intensity information, as shown in FIG. 5a. The second image frame 820 includes a plurality of image pixels v₁, v₂, . . . , vₘ, vₘ₊₁, . . . , v_{m×n}, and similarly each pixel vⱼ, wherein j=1 to m×n, includes at least a coordinate information and an intensity information, as shown in FIG. 5b. A motion estimation device, e.g. the first processing unit 306, determines a relative motion of the second image frame 820 with respect to the first image frame 810. The relative motion is a motion parameter defined by calculating the maximum value of a probability density function between the first image frame 810 and second image frame 820. The motion parameter is with the maximum likelihood value obtained according to the conditional probability of Baye's theorem, and it is served as a relative motion of the second image frame 820 with respect to the first image frame 810. The full disclosure of which can be found in U.S. patent application Ser. No. 11/420,715 entitled “Method and apparatus for estimating relative motion based on maximum likelihood” owned by the applicant. It should be noted that, the above calculation method is only an embodiment and is not used to limit the present invention. Any device which can be used to calculate a displacement of the cursor control device 3 with respect to the surface 2 does not depart from the spirit of the present invention. Embodiments of the first sensing unit 30 include an optical mouse, an optical navigation sensor and the like.

Referring to FIGS. 1a, 1b, 2 and 3 again, the first embodiment of the second sensing unit 31 includes an optical filter 312, a second sensor 314, a second processing unit 316 and a lens 318. Embodiments of the second sensor 314 include a CCD image sensor, CMOS image sensor and the like. The second sensor 314 is for continuously capturing at least two image frames of the objects 22 and 24 or the object 26. The second processing unit 316 calculates a variation between the image frames of the objects so as to calculate the second displacement of the cursor control device 3 with respect to the objects 22 and 24 or the object 26 and calculates a second coordinate variation of the cursor 21 according to the second displacement. The optical filter 312 is for blocking light with a spectrum outside a predetermined spectrum. An embodiment of the optical filter 312 is an infrared optical filter, and the predetermined spectrum would be infrared spectrum. In this manner, the second sensor 314 can detect the light only from the objects 22 and 24 or the object 26 so as to simplify the image recognition procedure. The lens 318 is disposed in front of the second sensor 314 so as to take images in focus; however it is not necessary to install the lens 318. In addition, it could be understood that, the front part of the house 300 is preferably made by light-transparent material such that the second sensor 314 can detect the light from the objects 22 and 24 or the object 26.

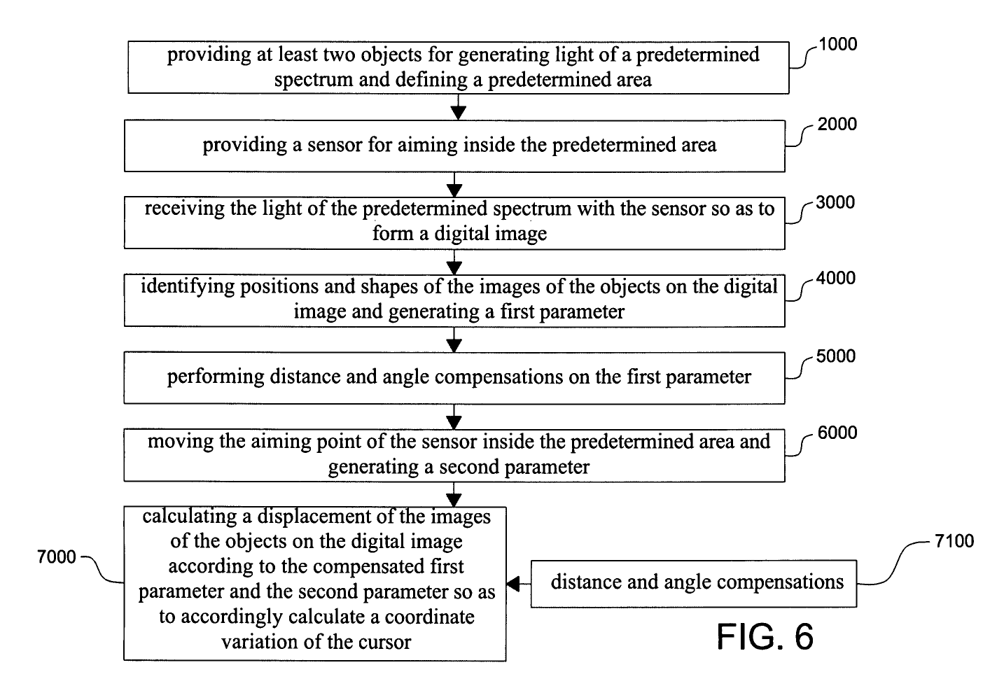

Referring to FIGS. 1b, 2, 3 and 6 to 9, an example for calculating the second displacement is illustrated hereinafter. The method includes the following steps: providing at least two objects for generating light of a predetermined spectrum and defining a predetermined area (step 1000); providing a sensor aiming inside the predetermined area (step 2000); receiving the light of the predetermined spectrum with the sensor so as to form a digital image (step 3000); identifying the positions and shapes of the images of the objects on the digital image and generating a first parameter (step 4000); performing distance and angle compensations on the first parameter (step 5000); moving the aiming point of the sensor inside the predetermined area and generating a second parameter (step 6000); and calculating a moving distance of the images of the objects on the digital image according to the compensated first parameter and the second parameter so as to accordingly calculate the coordinate variation of the cursor (step 7000); wherein in step 7000, distance and angle compensations are simultaneously performed on the second parameter (step 7100).

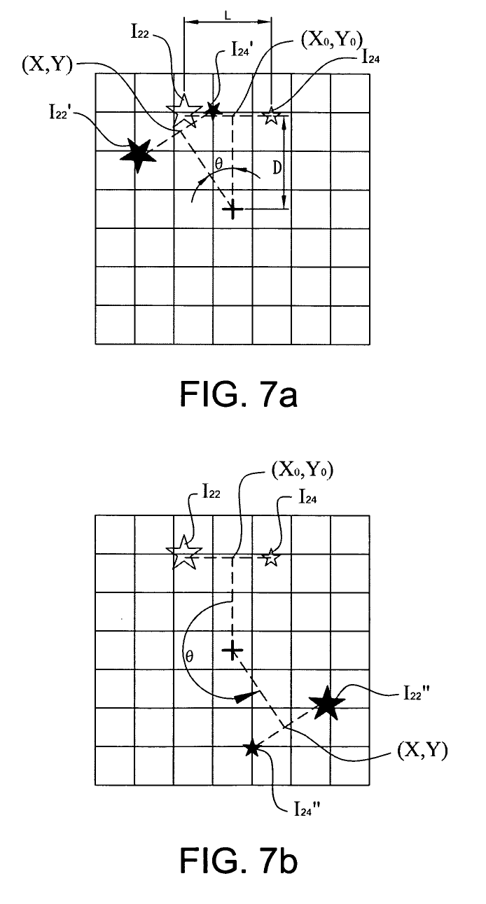

Before the cursor control device 3 leaves the factory, preferably a predetermined position parameter and a predetermined distance parameter are pre-stored in the memory unit 33. These parameters could be obtained from predetermined images I₂₂ and I₂₄ of the objects 22 and 24 captured by the sensor (for example the second sensor 314) at a predetermined distance, e.g. 3 meters, from the objects 22 and 24, as shown in FIG. 7a, and be served as references for the following distance and angle compensations. The predetermined position and distance parameters may be defined according to a plane space formed by the image sensor array of the second sensor 314, e.g. a plane space having the center of the image sensor array “+” as the original point, and the image sensor array herein is represented by a 7×7 pixel array. For example, the predetermined position parameter may be an average coordinate (X₀, Y₀) of the predetermined images I₂₂ and I₂₄ of the objects 22 and 24 in the above mentioned plane space; the predetermined distance parameter may include a distance “L” between the predetermined images I₂₂ and I₂₄ of the objects 22 and 24, and a distance “D” between the average coordinate (X₀, Y₀) of the predetermined images I₂₂ and I₂₄ and the center of the image sensor array “+”.

First, it is assumed that the objects 22 and 24 generate light of a predetermined spectrum, e.g. infrared spectrum in this embodiment, and that the area of the object 22 is larger than that of the object 24. In this manner, an image sensible area “A” surrounding the objects 22 and 24 can be determined according to the viewing angle of the second sensor 314 and the emitting angles of the objects 22 and 24 (step 1000). Next, the second sensor 314 of the cursor control device 3 is aimed at any place inside the image sensible area “A” (step 2000). Since an optical filter 312 is disposed in front of the second sensor 314, only the images of the objects 22 and 24 will appear on the image sensor array of the second sensor 314 (step 3000), shown as the images I₂₂′ and I₂₄′ in FIG. 7a. Because the cursor control device 3 is rotated clockwise by an angle θ while capturing the digital images, as the arrow direction shown in FIG. 1b, a rotation angle difference θ exists between the images I₂₂′ and I₂₄′ and the predetermined images I₂₂ and I₂₄, which is captured by the second sensor 314 at aforementioned predetermined distance. In this manner, the average coordinate (X, Y) of the images I₂₂′ and I₂₄′ dose not coincide with the average coordinate (X₀, Y₀) of the predetermined images I₂₂ and I₂₄ even though the second sensor 314 is aimed at identical position in these two statuses.

After the digital image is transmitted to the second processing unit 316, the second processing unit 316 identifies positions and shapes of the images I₂₂′ and I₂₄′ of the objects and generates a first position parameter, a first distance parameter and an image shape parameter (step 4000). The second processing unit 316 performs the angle compensation according to the rotation angle difference θ between the first position parameter (for example, including the average coordinate of the images I₂₂′ and I₂₄′ and the tilt angle of their connecting line) and the predetermined position parameter (including coordinates of the predetermined images I₂₂ and I₂₄ and a tilt angle of their connecting line) (step 5000). The angle compensation is implemented according to equation (1),

$$[ \begin{matrix}{X}^{′} \\ {Y}^{′}\end{matrix} ] = [ \begin{matrix}cos ( θ ) & - sin ( θ ) \\ sin ( θ ) & cos ( θ )\end{matrix} ] [ \begin{matrix}X \\ Y\end{matrix} ] \qquad ( 1 )$$

where θ denotes a rotation angle difference between the first position parameter and the predetermined position parameter; X and Y denote the average coordinates in the first position parameter before being compensated; X′ and Y′ (not shown) denote the average coordinates after being compensated. Therefore, after the rotation angle difference is compensated, the images of the objects 22 and 24 are compensated to images under the same basis, i.e. the second sensor 314 can capture identical images under any rotation angle as long as a user operating the cursor control device 3 at a constant distance from the objects 22 and 24 and aiming at the same point.

However, if the rotation angle difference θ is larger than 180 degrees so as to form the images I₂₂″ and I₂₄″ as shown in FIG. 7b, and if there is no difference between the objects 22 and 24, i.e. having identical sizes and shapes, it is unable to distinguish that the images I₂₂″ and I₂₄″ are formed from rotating or from moving the images I₂₂′ and I₂₄′ as shown in FIG. 7a. Therefore in this embodiment, two objects 22 and 24 with different sizes are utilized, and individual positions of the images of the objects 22 and 24 are identified first according to the image shape parameter, e.g. areas of the images of the objects, obtained by the second processing unit 316, and then the angle compensation will be performed. In this manner, the calculation of the second coordinate variation of the cursor 21 can be correctly performed even though the rotation angle of the second sensor 314 during operation exceeds 180 degrees.

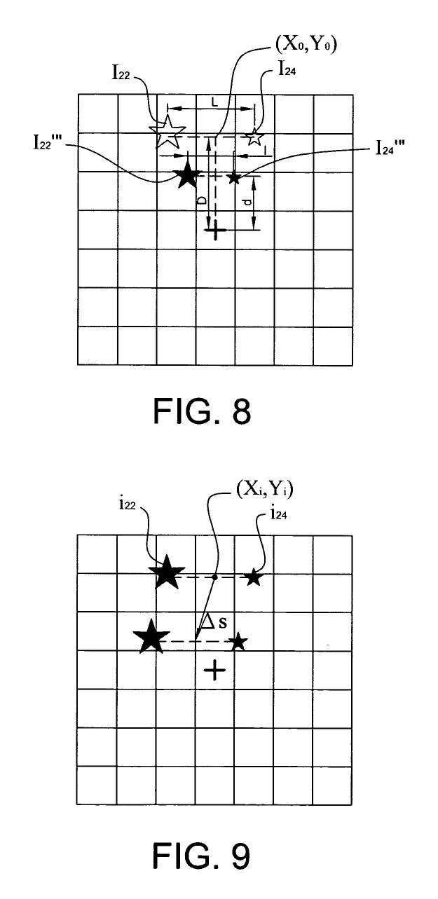

Referring to FIG. 8, it shows a method for distance compensation utilized in this embodiment. When a user uses the second sensor 314 of the cursor control device 3 to capture the images of the objects 22 and 24, if the distance between the cursor control device 3 and the objects 22 and 24 becomes larger, the captured images of the objects will become smaller and the average coordinate of the captured images of the objects 22 and 24 will become closer to the center “+” of the image sensor array. However, the position deviation caused by this action does not represent that the user changes the aiming point of the second sensor 314 of the cursor control device 3. If this kind of position deviation is not corrected, the change of photographing distance could induce incorrect movement during the calculation of the average coordinate (X,Y) of the images of the objects 22 and 24. In this embodiment, it is assumed that a distance between two predetermined images I₂₂ and I₂₄ is “L” and a distance between the average coordinate (X₀,Y₀) of the predetermined images I₂₂ and I₂₄ of the objects and the center “+” of the image sensor array is “D”; the first position parameter is “1” and a distance between the average coordinate of the images of the objects and the center “+” of the image sensor array is “d”. In this manner, the distance deviation can be compensated according to equation (2) (step 5000):

$$\frac{D}{L} = \frac{d}{l} \qquad ( 2 )$$

Referring to FIG. 9, it is assumed that the images after being compensated become i₂₂ and i₂₄, which are images based on the predetermined basis. Then move the aiming point of the cursor control device 3 inside the image sensible range “A” (step 6000), and the second sensor 314 continuously transmits signals of the digital image to the second processing unit 316. The second processing unit 316 generates a second parameter, which includes a second position parameter and a second distance parameter of the objects 22 and 24 on the digital image after the aiming point of the second sensor 314 is moved, according to the digital image. The second position parameter may be an average coordinate of the images of the objects 22 and 24 according to a plane space formed by the image sensor array of the second sensor 314, e.g. a plane space having the center “+” of the image sensor array as the original point; the second distance parameter may be a distance between the images of the objects 22 and 24 according to the same plane space. The second processing unit 316 calculates a moving distance ΔS (second displacement) of the images i₂₂ and i₂₄ according to the compensated first parameter and the second parameter, and the second parameter is compensated by the aforementioned distance and angle compensations during calculation (step 7100) so as to be able to correctly obtain the coordinate variation. Since the compensations of the second parameter are identical to that of the first parameter, the details will not be described herein. The full disclosure of calculating the second coordinate variation can be found in U.S. patent application Ser. No. 11/965,624 (claimed priority based on TW Pattern Application No. 095149408) entitled “cursor control apparatus and method” owned by the applicant. It should be noted that, the above calculation method is only an embodiment and is not used to limit the present invention. Any method which can be used to calculate the second coordinate variation of the cursor control device 3 does not depart from the spirit of the present invention.

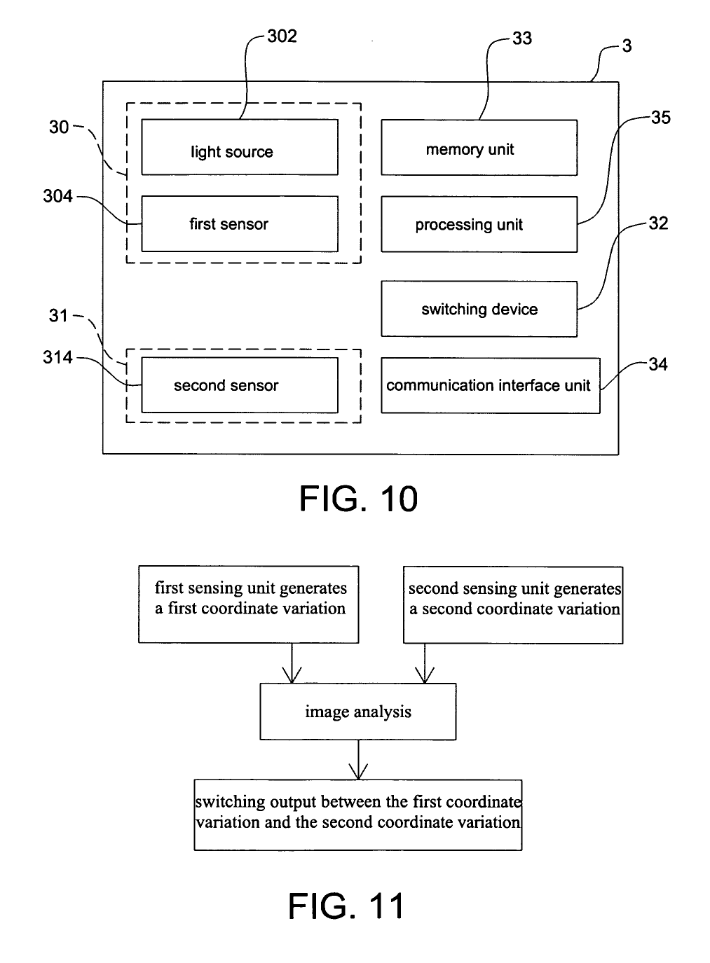

Referring to FIG. 10, it shows a block diagram of the cursor control device 3 according to the second embodiment of the present invention. The cursor control device 3 includes a first sensing unit 30, a second sensing unit 31, a switching device 32, a memory unit 33, a communication interface unit 34 and a processing unit 35. The difference between the second embodiment and the first embodiment is that, in the second embodiment, a user determines whether to use the first sensing unit 30 or the second sensing unit 31 to control the cursor 21 of the image display 2 according to an image analysis result, i.e. the processing unit 35 performs an image analysis first and then controls the switching device 32 to output the first coordinate variation through the first sensing unit 30 or to output the second coordinate variation through the second sensing unit 31 according to a result of the image analysis.

Referring to FIG. 11, it shows the cursor control method for the image display 2 according to the second embodiment of the present invention. The method includes the following steps: utilizing the first sensing unit 30 to detect a first displacement of the cursor control device 3 with respect to the surface S and to calculate a first coordinate variation of the cursor 21 on the image display 2 according to the first displacement; utilizing the second sensing unit 31 to sense the objects 22 and 24 or the object 26, to detect a second displacement of the cursor control device 3 with respect to the objects 22 and 24 or the object 26, and to calculate a second coordinate variation of the cursor 21 on the image display 2 according to the second displacement; and outputting the first coordinate variation or the second coordinate variation from the cursor control device; wherein a method to determine whether to output the first coordinate variation or the second coordinate variation is by analyzing sensed image. For example, when the second sensing unit 31 senses the image of the objects 22, 24 or the object 26, the processing unit 35 controls the switching device 32 to select the second sensing unit 31 to output the second coordinate variation of the cursor 21. In addition, the first sensing unit 30 also includes the light source 302, the first sensor 304 and the lens 308; the second sensing unit 31 also includes the optical filter 312, the second sensor 314 and the lens 318.

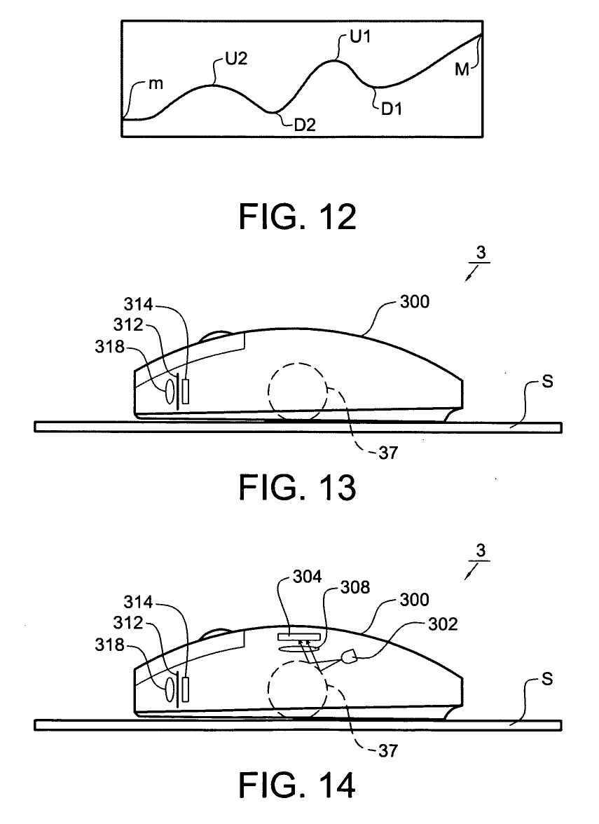

Referring to FIGS. 10 and 12, FIG. 12 shows a method that the processing unit 35 analyzes the quality of the images captured by the first sensor 304 according to this embodiment, wherein there are variations in intensity values of the image pixels in one dimension captured by the first sensor 304, i.e. there is at least one local maximum in intensity values. The quality of the images in one dimension is determined by the peaks of the intensity values, wherein the peak is defined as follows:

upper peak: a pixel in one dimension of a frame in which pixels on two sides of the dimension have smaller intensity values than that of the pixel to some extent, e.g. U1, U2 shown in FIG. 12.

down peak: a pixel in one dimension of a frame in which pixels on two sides of the dimension have larger intensity values than that of the pixel to some extent, e.g. D1, D2 shown in FIG. 12.

A pixel at an edge of one dimension of the frame, e.g. the pixel with the intensity value as M in FIG. 12, is not defined as an upper peak even when the pixel has a maximum intensity value; a pixel which is at an edge of one dimension of the frame, e.g. the pixel with the intensity value as m in FIG. 12, is not defined as a down peak even when the pixel has a minimum intensity value. The number of the upper peaks or the down peaks can be counted as the number of the peaks of intensity values in one dimension, and when the number of the peaks exceeds a critical number in one dimension, the number in one dimension is defined qualified. It could be understood that, the critical number of the peaks is different according to different size of the image sensor array.

When an image frame in two dimensions had been read by an optical mouse (for example the first sensor 304), the number of the peaks in two dimensions was calculated completely. The number of the peaks in two dimensions, which satisfies requirements, depends on application. For example, if at least one column or one row satisfies requirement, or each column satisfies requirements, or each row satisfies requirements, then the image frame in two dimensions meets requirements and is defined as a good image frame. Otherwise, it is determined that the image frame does not meet requirements and is a bad image frame. When the processing unit 35 identifies the image frame captured by the first sensor 304 to be good, it controls the switching device 32 to select the first sensor 304 to output the first coordinate variation of the cursor 21; on the other hand, when the image captured by the first sensor 304 is identified to be bad, the processing unit 35 controls the switching device 32 to select the second sensor 314 to output the second coordinate variation of the cursor 21. The full disclosure of the method to identify the quality of the image captured by the first sensor 304 can be referred in U.S. patent application Ser. No. 10/286,113 (claimed priority base on Taiwan Paten No. 526,662) entitled “Image qualification for optical navigation sensor” owned by the applicant. It should be noted that, the above mentioned method is only an exemplary embodiment and is not used to limit the present invention. Any method which can be used to analyze the image captured by the first sensor 304 such that the processing unit 35 can control the switching device 32 to select to output the first or the second coordinate variation according to an image analysis result does not depart from the spirit of the present invention.

Referring to FIG. 13, it schematically shows an image control device 3 according to another embodiment of the present invention, wherein the first sensor 304 is a wheel mouse for detecting the first displacement of the cursor control device 3 with respect to the surface S and calculating the first coordinate variation of the cursor 21 according to the first displacement. In the image control device 3, a ball 37 is rotatably disposed inside the lower part of the house 300 and two rolling wheels (not shown) are respectively disposed in the X-axis and Y-axis directions next to the ball 37. By moving the house 300 on the surface S, the ball 37 is rolled so as to bring the two rolling wheels to rotate respectively along two axes, and two-dimensional coordinative position signals used for generating the first coordinate variation can be generated so as to accordingly control the movement of the cursor 21 on the screen 20. In addition, inside the house 300, there is also installed with the second sensing unit 31 which includes the optical filter 312, the second sensor 314 and the lens 318. And since the functions and operations of these components are identical to that mentioned above, their details will not be illustrated herein.

Referring to FIG. 14, it shows a cursor control device 3 according to another embodiment of the present invention, wherein the first sensing unit 30 is another sort of wheel mouse and is for detecting the first displacement of the cursor control device 3 with respect to the surface S and for calculating the first coordinate variation of the cursor 21 according to the first displacement. The first sensing unit 30 includes a light source 302, a ball 37, a first sensor 304 and a lens 308, wherein the light source 302 may be a laser diode. The light source 302 of the cursor control device 3 lights the surface of the ball 37, and the first sensor 304 detects the laser light reflected from the surface of the ball 37. When the ball 37 is rolled, the first sensor 304 can detect the reflected interfering image of the laser light and then analyzes the image so as to determine the relative moving direction and displacement of the surface of the ball 37 with respect to the surface S so as to obtain the first coordinate variation. In addition, inside the house 300, there is also installed with the second sensing unit 31 which includes the optical filter 312, the second sensor 314 and the lens 318. And since the functions and operations of these components are identical to that mentioned above, their details will not be illustrated herein.

As described above, because it is necessary to further purchase anther pointer positioning device so as to execute, for example a shooting game on the conventional image display, the cost and system complexity will be increased. By using the cursor control device for an image display of the present invention (as shown in FIGS. 1a and 1b), which can control the displaying and setting of the image display in two ways by means of a switching mechanism, a user need not to purchase another system and therefore it has the effect of simplifying the system and of decreasing the cost.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A cursor control device for an image display, comprising:
a first sensing unit for detecting a first displacement of the cursor control device with respect to a surface and calculating a first coordinate variation of a cursor on the image display according to the first displacement;
a second sensing unit for sensing an object, detecting a second displacement of the cursor control device with respect to the object and calculating a second coordinate variation of the cursor on the image display according to the second displacement; and
a switching device for switching output between the first coordinate variation and the second coordinate variation.

2. The cursor control device as claimed in claim 1, further comprising a processing unit for calculating the first and the second coordinate variations.

3. The cursor control device as claimed in claim 2, wherein the first sensing unit further comprises:
a light source for lighting the surface so as to form a first image; and
a first sensor for capturing at least two image frames of the first image reflected from the surface;
wherein the processing unit calculates the first displacement of the cursor control device with respect to the surface according to a variation between the image frames of the first image and calculates the first coordinate variation of the cursor on the image display according to the first displacement.

4. The cursor control device as claimed in claim 3, wherein the first sensing unit is an optical mouse or an optical navigation sensor.

5. The cursor control device as claimed in claim 3, wherein the processing unit controls the switching device to switch output between the first coordinate variation and the second coordinate variation according to an image analysis result of the image frames of the first image captured by the first sensor.

6. The cursor control device as claimed in claim 3, wherein the processing unit controls the switching device to switch output between the first coordinate variation or the second coordinate variation according to the number of peaks of the intensity value in the image frames of the first image captured by the first sensor.

7. The cursor control device as claimed in claim 2, wherein the second sensing unit further comprises:
a second sensor for sensing the object and capturing at least two image frames of the object;
wherein the processing unit calculates the second displacement of the cursor control device with respect to the object according to a variation between the image frames of the object and calculates the second coordinate variation of the cursor on the image display according to the second displacement.

8. The cursor control device as claimed in claim 7, wherein when the second sensor senses the image of the object, the processing unit controls the switching device to switch to output the second coordinate variation.

9. The cursor control device as claimed in claim 1, wherein the first sensing unit is a wheel mouse.

10. The cursor control device as claimed in claim 1, wherein the first sensing unit further comprises:
a light source for lighting the surface so as to form a first image;
a first sensor for capturing at least two image frames of the first image reflected from the surface; and
a first processing unit for calculating the first displacement of the cursor control device with respect to the surface according to a variation between the image frames of the first image and calculating the first coordinate variation of the cursor on the image display according to the first displacement.

11. The cursor control device as claimed in claim 1, wherein the second sensing unit further comprises:
a second sensor for sensing the object and capturing at least two image frames of the object;
a second processing unit for calculating the second displacement of the cursor control device with respect to the object according to a variation between the image frames of the object and calculating the second coordinate variation of the cursor on the image display according to the second displacement.

12. An image system, comprising:
an image display comprising a screen for displaying image pictures with a cursor shown thereon;
at least one object;
a cursor control device, comprising:
a first sensing unit for detecting a first displacement of the cursor control device with respect to a surface and calculating a first coordinate variation of the cursor according to the first displacement;
a second sensing unit for sensing the object, detecting a second displacement of the cursor control device with respect to the object and calculating a second coordinate variation of the cursor according to the second displacement;
a switching device for switching output between the first coordinate variation or the second coordinate variation; and
a communication interface unit for transmitting the first coordinate variation or the second coordinate variation selected to be outputted by the switching device; and
a coordinate processor for receiving the first coordinate variation or the second coordinate variation from the communication interface unit and combining the first coordinate variation or the second coordinate variation with the coordinate of the cursor on the image display such that the cursor control device can accordingly control the motion of the cursor on the screen.

13. The image system as claimed in claim 12, wherein the cursor control device is a mouse or a game control device.

14. The image system as claimed in claim 12, wherein the object has a predetermined shape shown on the screen of the image display.

15. A cursor control method for an image display, comprising:
providing a cursor control device comprising a first sensing unit and a second sensing unit;
detecting a first displacement of the cursor control device with respect to a surface and calculating a first coordinate variation of a cursor on the image display according to the first displacement with the first sensing unit;
sensing an object, detecting a second displacement of the cursor control device with respect to the object and calculating a second coordinate variation of the cursor on the image display according to the second displacement with the second sensing unit; and
outputting the first coordinate variation or the second coordinate variation from the cursor control device.

16. The cursor control method as claimed in claim 15, wherein in the step of calculating a first coordinate variation further comprises:
lighting the surface so as to form a first image;
capturing at least two image frames of the first image reflected from the surface; and
calculating the first displacement of the cursor control device with respect to the surface according to a variation between the image frames of the first image and calculating the first coordinate variation of the cursor on the image display according to the first displacement.

17. The cursor control method as claimed in claim 16, wherein the cursor control device determines to output the first coordinate variation or the second coordinate variation according to an image analysis result of the captured image frames of the first image.

18. The cursor control method as claimed in claim 16, wherein the cursor control device determines to output the first coordinate variation or the second coordinate variation according to the number of peaks of the intensity value in the captured image frames of the first image.

19. The cursor control method as claimed in claim 15, wherein the cursor control device determines to output the second coordinate variation when the second sensing unit senses the image of the object.

20. The cursor control method as claimed in claim 15, wherein in the step of calculating a second coordinate variation further comprises:
sensing the object and capturing at least two image frames of the object; and
calculating the second displacement of the cursor control device with respect to the object according to a variation between the image frames of the object and calculating the second coordinate variation of the cursor on the image display according the second displacement.

21. A cursor control method for an image display, comprising:
providing a cursor control device comprising a first sensing unit and a second sensing unit;
detecting a first displacement of the cursor control device with respect to a surface and calculating a first coordinate variation of a cursor on the image display according to the first displacement with the first sensing unit;
outputting the first coordinate variation from the cursor control device when a predetermined condition is met; and
sensing an object, detecting a second displacement of the cursor control device with respect to the object and calculating a second coordinate variation of the cursor on the image display according to the second displacement with the second sensing unit, and outputting the second coordinate variation from the cursor control device when the predetermined condition is not met.

22. The cursor control method as claimed in claim 21, wherein in the step of calculating a first coordinate variation further comprises:
lighting the surface so as to form a first image;
capturing at least two image frames of the first image reflected from the surface; and
calculating the first displacement of the cursor control device with respect to the surface according to a variation between the image frames of the first image and calculating the first coordinate variation of the cursor on the image display according to the first displacement.

23. The cursor control method as claimed in claim 22, wherein when the number of peaks of the intensity value in the captured image frames of the first image is larger than a predetermined number, the predetermined condition is met.

24. The cursor control method as claimed in claim 21, wherein when a switching device of the cursor control device is triggered, the predetermined condition is met.

25. The cursor control method as claimed in claim 21, wherein in the step of calculating a second coordinate variation further comprises:
sensing the object and capturing at least two image frames of the object; and
calculating the second displacement of the cursor control device with respect to the object according to a variation between the image frames of the object and calculating the second coordinate variation of the cursor on the image display according to the second displacement.
